(19) United States
(12) Patent Application Publication
(10) Pub. No.: US 2010/0057505 A1
(43) Pub. Date: Mar. 4, 2010

(54) BUSINESS PROCESS COMMUNITY INPUT

(75) Inventors: Ronald P. Doyle, Raleigh, NC (US); Edith H. Stern, Yorktown Heights, NY (US); Barry E. Willner, Briarcliff Manor, NY (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 12/199,626

(22) Filed: Aug. 27, 2008

(51) Int. Cl. G06Q 10/00

(52) U.S. Cl. 705/7

(57) ABSTRACT

A community input method can be provided. The method can include receiving from an end user a request to access a portion of a workflow in a business process instance, prompting the end user to provide community input to community documentation for the portion of the workflow, and rendering the community documentation accessible by other end users accessing the portion of the workflow. Optionally, an interval (whether fixed or random) of a number of end users requesting access to the portion of the workflow in the business process instance can be determined, and the end user can be programmatically prompted to provide community input only if the request from the end user is received on the determined interval.

### BACKGROUND OF THE INVENTION

The present invention broadly relates to the field of business process use in a computing environment and more particularly relates to the field business process documentation.

A business process can be defined as a set of interrelated tasks linked to an activity that spans functional boundaries. Business processes have starting points and ending points, and business processes are repeatable. Business processes often incorporate workflows. A workflow is a depiction of a sequence of operations, declared as work of a person, work of a simple or complex mechanism, work of a group of persons, work of an organization of staff, or machines. Workflow may be seen as any abstraction of real work and thus can model real work for further assessment, for instance in describing a reliably repeatable sequence of operations. More abstractly, a workflow is a pattern of activity enabled by a systematic organization of resources, defined roles and mass, energy and information flows, into a work process that can be documented and learned.

Business process management data processing systems provide a user interface through which business processes can be defined and workflows specified as part of the defined business processes. Business process management data processing systems further provide a mechanism for creating instances of a defined business process and for managing the progress of performing the workflows in each instance of a defined business process. Inclusive within the management of an instance of a defined business process is the management of access control for users and the storage of data accumulated in the course of completing the workflows of the instance of the defined business process.

A business process can be complicated once defined and generally represents the expertise of the architect defining the business process within the subject matter space contextually relevant to the defined business process. It has long been recognized that users participating in a defined business process are a prime source of knowledge about the defined business process. The “Quality Circle” is demonstrative of the natural manner in which the collective knowledge of users can be tapped for their knowledge in order to improve quality in manufacturing processes. As it is known in the art, a Quality Circle is a volunteer group composed of workers who meet in person to discuss workplace improvement, to make presentations to management with ideas, especially relating to quality of output in order to improve the performance of the organization, and to motivate and to enrich the work of fellow employees.

Notwithstanding, the current business process design methodology does not support commentary from the workers in the process in an organized way. In fact, the notion of the Quality Circle is wholly lacking in conventional business process management data processing systems. Rather, current best practices include only the drafting of help text for a defined business process by information technologists charged with the implementation of a business process definition. External to the defined business process, users can create supplementary material distributed electronically via discussion for a, wikis, suggestion boxes, and the like. However, this input is often difficult to find and associate with specific process steps of a defined business process.

### BRIEF SUMMARY OF THE INVENTION

In one embodiment of the invention, a community input method can be provided. The method can include receiving from an end user a request to access a portion of a workflow in a business process instance, prompting the end user to provide community input to community documentation for the portion of the workflow, and rendering the community documentation accessible by other end users accessing the portion of the workflow. Optionally, an interval (whether fixed or random) of a number of end users requesting access to the portion of the workflow in the business process instance can be determined, and the end user can be programmatically prompted to provide community input only if the request from the end user is received on the determined interval.

In one aspect of the embodiment, prompting the end user to provide community input to community documentation for the portion of the workflow can include prompting the end user to provide community input to community documentation for a group to which the end user belongs for the portion of the workflow. In another aspect of the embodiment, rendering the community documentation accessible by other end users accessing the portion of the workflow can include rendering a listing of end users who have previously accessed the portion of the workflow. In yet another aspect of the embodiment, the method also can include messaging a creator of the portion of the workflow with the community input provided by the end user.

In another embodiment of the invention, a business process management (BPM) data processing system can be provided. The system can include a BPM server coupled to an enterprise service bus (ESB) and managing at least one instance of a business process comprising at least one workflow. The system also can include a documentation server such as a Wiki, shared document library or discussion forum, including community documentation corresponding to at least a portion of a workflow for the business process instance. Finally, a community input process can be provided. The process can include program code enabled to prompt an end user to provide community input to the community documentation for the portion of the workflow such as a task in response to a request by the end user to access the portion of the workflow and also to retrieve from the documentation server the community documentation responsive to a request by other end users to access the portion of the workflow so as to render the community documentation accessible by other end users accessing the portion of the workflow.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention.

FIG. 1 is a pictorial illustration of a process for incorporating community input in documenting a business process;

FIG. 2 is a schematic illustration of a business process management data processing system configured for incorporating community input in documenting a business process; and,

FIG. 3 is a flow chart illustrating a process for incorporating community input in documenting a business process.

### DETAILED DESCRIPTION OF THE INVENTION

As will be appreciated by one skilled in the art, the present invention may be embodied as a method, data processing system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In an embodiment of the invention, a business process instance can be created to include one or more workflows, each workflow being associated with one or more end users or roles for end users. A community repository of community input, for example text, imagery, audio or audio visual input, can be associated with at least a portion of a workflow in the business process instance, the community repository of text providing a common forum into which commentary can be provided by end users interacting with the associated portion of the workflow. During execution of the business process, text in the community repository relating to the associated portion of the workflow can be rendered accessible in connection with accessing the associated portion of the workflow. Further, when interacting with the associated portion of the workflow, an end user can be prompted to provide community input into the community repository relating to the associated portion of the workflow. In this way, community input pertaining to the workflows of the business process instance can be incorporated dynamically as documentation for the workflows of the business process instance.

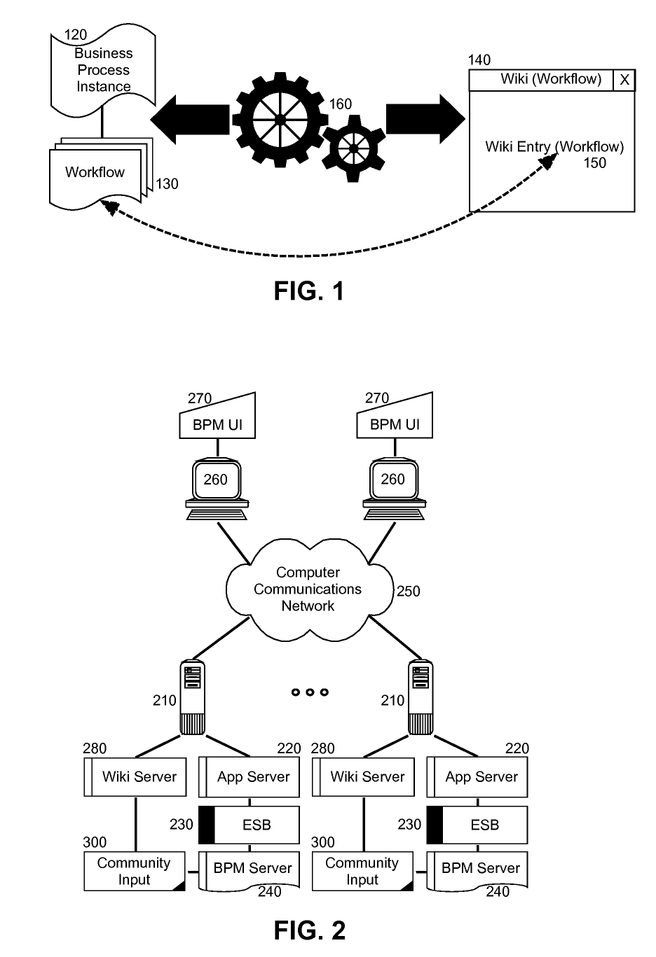

In illustration, FIG. 1 pictorially shows a process for incorporating community input in documenting a business process. As shown in FIG. 1, a business process instance 120 can include one or more workflows 130, each of the workflows 130 including one or more tasks to be completed by one or more end users expressly or implicitly by role for the end users. Community documentation 140, for example a Wiki or discussion forum, can be associated with at least a portion of each of the workflows 130, for example on a task by task basis. Optionally, community documentation 140 can be provided on a group by group basis so that different community documentation 140 can be provided for the same portion of a workflow depending upon the membership of an end user in a particular group.

Community input process 160 also can be provided to induce documentation input 150 in community documentation 140 responsive to user interaction with at least a portion of the each of the workflows 130 and further, documentation input 150 provided in the community documentation 140 for a given portion of a particular one of the workflows 130 can be rendered accessible to other end users interacting with the given portion of the particular one of the workflows 130.

The process described in connection with FIG. 1 can be implemented in a business process management data processing system. In further illustration, FIG. 2 is a schematic illustration of a business process management data processing system configured for incorporating community input in documenting a business process. The system can include one or more host servers 210 configured for coupling to different clients 260 over computer communications network 250. Each of the host servers 210 can support the operation of an application server 220 managing the execution of an enterprise service bus 230. A BPM server 240 further can be provided in connection with the enterprise service bus 230 in order to support the execution of a portion of a distributed business process instance accessible by end users through a respective BPM user interface 270 in each of the clients 260.

Of note, community input process 300 can be coupled to the BPM server 240. Community input process 300 can be coupled to a documentation host 280 such as a Wiki server or discussion forum or shared document library and the process 300 can include program code enabled to induce community input in the documentation host 220 for a portion of a workflow of a business process instance. In this regard, as an end user interacts with a portion of a workflow such as a task, a request can be indicated through the BPM user interface 270 to provide input documenting the portion of the workflow. The request can be proactive such as a popup dialog box or passive such as a visually distinguished user interface control, by way of example. The program code of the process 300 further can be enabled to render access to a view to community input corresponding to a selected portion of a workflow as an end user interacts with the selected portion in order to permit the end user to view postings to the community input for the selected portion of the workflow.

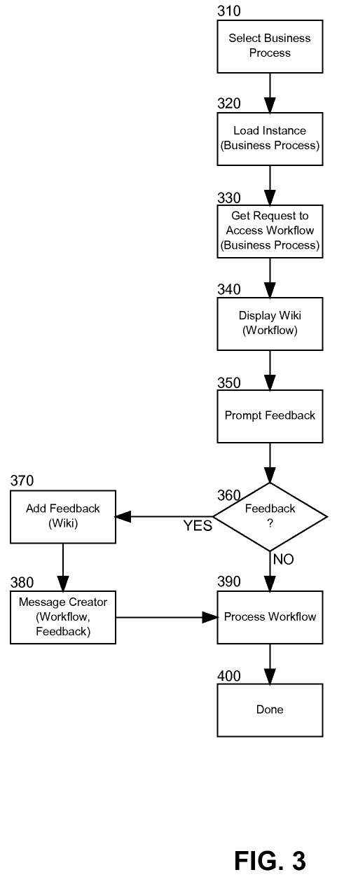

In yet further illustration of the operation of the community input process 300, FIG. 3 is a flow chart illustrating a process for incorporating community input in documenting a business process. Beginning in block 310, a business process can be selected and in block 320, an instance of the selected business process can be loaded. In block 330, a request to access a portion of a workflow for the instance of the business process can be received from an end user. For example, the request can flow from an end user selecting a task in a workflow. Thereafter, community documentation such as documentation in the form of a Wiki can be retrieved in association with the portion of the workflow in block 340 and access can be enabled for the community documentation from a user interface to the portion of the workflow, for example by way of a hyperlink or button. In one aspect of the embodiment, the community documentation can include a list of users that have previously performed a step of the workflow, including a date of performance. Additionally, directory access to the users in the list can be provided including hot links to instant messaging or e-mail to the users in the list.

In block 350, the end user can be prompted to provide community input into the community documentation, including commentary, suggested revisions, links to alternative workflows or tasks, or a known acceptable process for completing the portion of the workflow. For example, the end user can be prompted programmatically for every request to access the portion of the workflow, for every other request, or some other specified interval. Alternatively, the end user can be prompted at random intervals according to a desired probability distribution. In either circumstance, in decision block 360 it can be determined whether or not the end user has provided community input into the community documentation. If so, in block 370 the community input can be submitted for addition to the community documentation. Optionally, a message containing a reference to the portion of the workflow and the provided community input can be routed in block 380 to the creator of the portion of the workflow. Finally, in block 390, the portion of the workflow as performed by the end user can be processed and in block 400 the process can end.

Having thus described the invention of the present application in detail and by reference to embodiments thereof, it will be apparent that modifications and variations are possible without departing from the scope of the invention defined in the appended claims

We claim:

1. A community input method comprising:
receiving from an end user a request to access a portion of a workflow in a business process instance;
receiving from the end user community input to community documentation for the portion of the workflow; and,
rendering the community documentation accessible by other end users accessing the portion of the workflow.

2. The method of claim 1, wherein receiving from the end user community input to community documentation for the portion of the workflow, comprises prompting the end user to provide community input to community documentation for the portion of the workflow.

3. The method of claim 2, wherein prompting the end user to provide community input to community documentation for the portion of the workflow, comprises:
determining an interval of a number of end users requesting access to the portion of the workflow in the business process instance; and,
programmatically prompting the end user to provide community input only if the request from the end user is received on the determined interval.

4. The method of claim 3, wherein determining an interval of a number of end users requesting access to the portion of the workflow in the business process instance, comprises determining a random interval of a number of end users requesting access to the portion of the workflow in the business process instance.

5. The method of claim 2, wherein prompting the end user to provide community input to community documentation for the portion of the workflow, comprises prompting the end user to provide community input to community documentation for a group to which the end user belongs for the portion of the workflow.

6. The method of claim 1, wherein rendering the community documentation accessible by other end users accessing the portion of the workflow, comprises rendering a listing of end users who have previously accessed the portion of the workflow.

7. The method of claim 1, further comprising messaging a creator of the portion of the workflow with the community input provided by the end user.

8. A business process management (BPM) data processing system comprising:
a BPM server coupled to an enterprise service bus (ESB) and managing at least one instance of a business process comprising at least one workflow;
a documentation server comprising community documentation corresponding to at least a portion of a workflow for the business process instance; and,
a community input process comprising program code enabled to prompt an end user to provide community input to the community documentation for the portion of the workflow responsive to a request by the end user to access the portion of the workflow and also to retrieve from the documentation server the community documentation responsive to a request by other end users to access the portion of the workflow so as to render the community documentation accessible by other end users accessing the portion of the workflow.

9. The system of claim 8, wherein the community documentation is a Wiki.

10. The system of claim 8, wherein the portion of the workflow is a task in the workflow.

11. The system of claim 8, wherein the community documentation server comprises different community documentation each corresponding to at least a portion of a workflow for the business process instance and a particular group of end users.

12. A computer program product for community input in a business process management (BPM) data processing system, the computer program product comprising a computer usable medium having computer usable code embodied therewith, the computer usable code comprising:
computer usable program code for receiving from an end user a request to access a portion of a workflow in a business process instance;
computer usable program code for receiving from the end user community input to community documentation for the portion of the workflow; and,
computer usable program code for rendering the community documentation accessible by other end users accessing the portion of the workflow.

13. The computer program product of claim 12, wherein the computer usable program code for receiving from the end user community input to community documentation for the portion of the workflow, comprises computer usable program code for prompting the end user to provide community input to community documentation for the portion of the workflow.

14. The computer program product of claim 13, wherein the computer usable program code for prompting the end user to provide community input to community documentation for the portion of the workflow, comprises:
computer usable program code for determining an interval of a number of end users requesting access to the portion of the workflow in the business process instance; and,
computer usable program code for programmatically prompting the end user to provide community input only if the request from the end user is received on the determined interval.

15. The computer program product of claim 14, wherein the computer usable program code for determining an interval of a number of end users requesting access to the portion of the workflow in the business process instance, comprises computer usable program code for determining a random interval of a number of end users requesting access to the portion of the workflow in the business process instance.

16. The computer program product of claim 12, wherein the computer usable program code for prompting the end user to provide community input to community documentation for the portion of the workflow, comprises computer usable program code for prompting the end user to provide community input to community documentation for a group to which the end user belongs for the portion of the workflow.

17. The computer program product of claim 12, wherein the computer usable program code for rendering the community documentation accessible by other end users accessing the portion of the workflow, comprises computer usable program code for rendering a listing of end users who have previously accessed the portion of the workflow.

18. The computer program product of claim 12, further comprises computer usable program code for messaging a creator of the portion of the workflow with the community input provided by the end user.
